(19) United States
(12) Patent Application Publication
(10) Pub. No.: US 2013/0060717 A1
(43) Pub. Date: Mar. 7, 2013

(54) COMPREHENSIVE SAVINGS AND INVESTMENT METHOD AND SYSTEM

(71) Applicant: The Standard Life Assurance Company Of Canada, Montreal (CA)

(72) Inventors: Sylvain MESSIER, Montreal (CA); Ronald Eric LAURSEN, Montreal (CA); Robert H. CONYERS, Ville Mont-Royal (CA); Ingrid GENDREAU, Montreal (CA)

(73) Assignee: THE STANDARD LIFE ASSURANCE COMPANY OF CANADA, Montreal (CA)

(21) Appl. No.: 13/666,274

(22) Filed: Nov. 1, 2012

Related U.S. Application Data
(63) Continuation of application No. 13/446,791, filed on Apr. 13, 2012.
(60) Provisional application No. 61/475,799, filed on Apr. 15, 2011.

(51) Int. Cl. G06Q 40/06

(52) U.S. Cl. 705/36 R

(57) ABSTRACT

In an automated savings and investment system, a Service Provider negotiates agreements with each one of a plurality of parties defining terms under which funds can be transferred from the respective party to the Service Provider on behalf of a subscriber. The Service Provider defines enhanced services under which deposit amounts can be supplemented with additional funds. The Service Provider identifies, from among the plurality of parties, a set of parties with which a given subscriber has a financial relationship and enables the subscriber to subscribe to one or more of the agreements; identifies a set of permissible enhanced services to which the subscriber is permitted to subscribe, and enables the subscriber to select at least one of the permissible enhanced services. A server receives and accumulates deposit amounts in an account associated with the subscriber; and automatically invests accumulated deposit amounts in accordance with investment preferences of the subscriber.

### CROSS-REFERENCE TO RELATED APPLICATIONS

This application is a continuation application of U.S. patent application Ser. No. 13/446,791 filed Apr. 15, 2012 which is based on, and claims benefit of US Provisional Patent Application No. 61/475,799 filed Apr. 15, 2011, the entire content of which is incorporated herein by reference.

### MICROFICHE APPENDIX

Not Applicable.

### TECHNICAL FIELD

The present invention relates to savings and investment systems, and in particular to a comprehensive automated savings and investment method and system.

### BACKGROUND

Numerous savings and investment programs are well known in the art. Whether through distinct agreements or in an integrated services offer, savings and investment programs (ISPs) on the market allow customers to make pre-planned deposits to a savings or investment account, and then decide on specific investments to be purchased with the deposited money. Sometimes these conventional ISP's are offered within one financial institution; other times, they are not.

Typically, whether or not both functions take place at only one juncture point, the customer will instruct in advance the financial institution which collects the funds on how and where the funds he/she has deposited in his/her account can be transferred to an investment account of his/her choice, without the need for the customer to enter into separate formal agreements with his or her savings and investment institution(s). The financial institution will follow pre-established customer instructions to take all or some of the existing funds in a customer's savings account(s) and re-direct them to acquit a debt or transfer/invest into different accounts pre-selected by the customer.

### SUMMARY

The present invention provides computer and networking systems configured to implement a Comprehensive Investment & Savings Program (the “CISP”), which improves on the conventional ISP model described above by providing new features which significantly improve an individual's ability to save and invest.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating elements of a system implementing a Comprehensive Investment & Savings Program (CISP); and

FIG. 2 is a block diagram schematically illustrating elements of a CISP.

It will be noted that throughout the appended drawings, like features are identified by like reference numerals.

### DETAILED DESCRIPTION

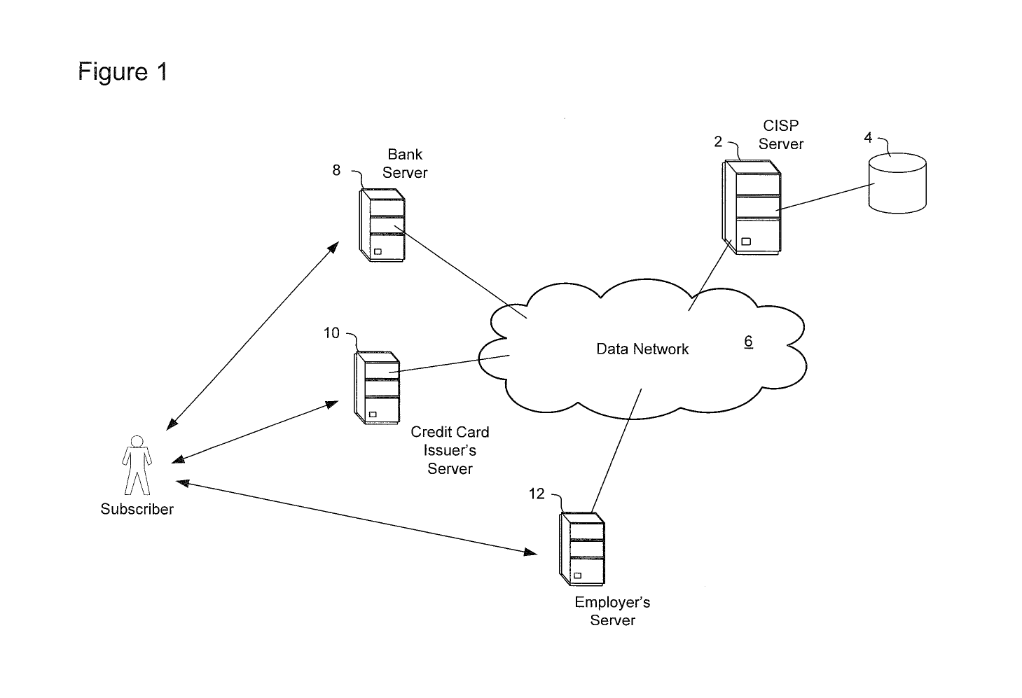

Referring to FIG. 1, there is shown a block diagram schematically illustrating elements of a system implementing a Comprehensive Investment & Savings Program (CISP). In the embodiment of FIG. 1, a CISP server 2 managed by a Service Provider is configured to maintain a database 4 including information about subscriber accounts as will be described in greater detail below. The CISP server 2 is connected to a data network 6 for communication with one or more servers maintained by parties with whom the subscriber may have a financial relationship. In the embodiment of FIG. 1, the subscriber has a financial relationship with a bank, a Credit Card Issuer, and an Employer, each of whom maintains a respective server 8-12 that is capable of exchanging financial information with the CISP server 2 via the data network 6.

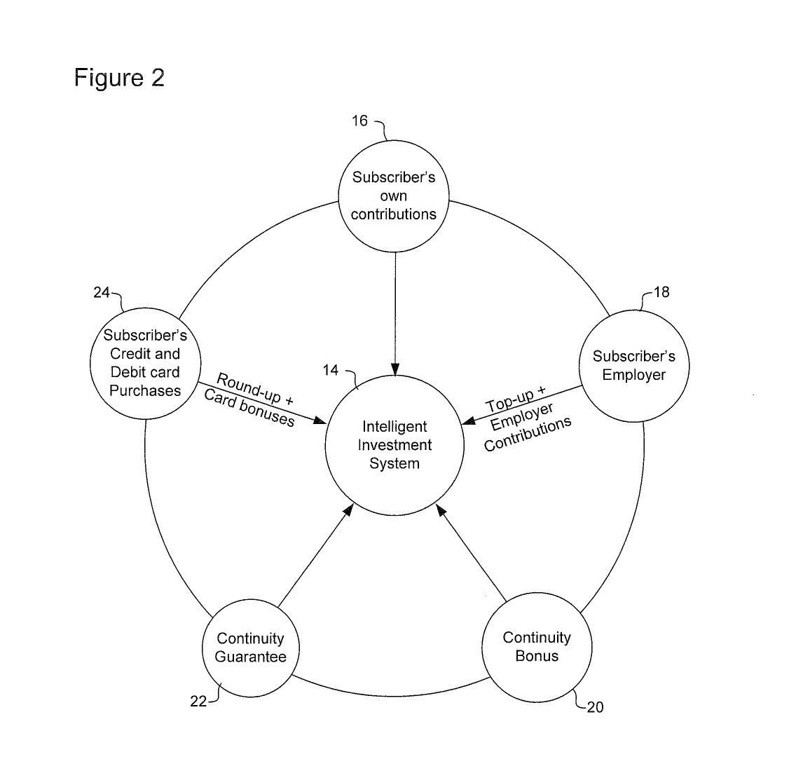

FIG. 2 illustrates functional elements of a representative Comprehensive Investment and Savings Program (CISP) that may be implemented using the system of FIG. 1. In the illustrated embodiment, the CISP implements an Intelligent Investment System 14 which receives and processes monetary transfers from various sources on behalf of subscribers. In the embodiment of FIG. 2, these sources include the Subscriber's own contributions 16, contributions from the Subscriber's employer 18, Continuity Bonuses 20 that may be offered by the Service Provider, Continuity Guarantees 22 that may be offered by the Service Provider, and contributions associated with Subscriber's purchasing activities 24. The CISP may offer any one or more of the following features to its subscribers:

First, while the proposed CISP includes the possibility for its subscribers to invest in specific investments (the “CISP Investments”) any card bonuses paid out by card issuers on the basis of credit or debit card usage, it also creates a new source of automated savings through a rounding-up concept (the “Rounding-Up Savings Method”) applied to selected purchases made by subscribers. In some embodiments, a “CISP Card” or the like may be issued to a subscriber for use while making regular purchases. If desired any other suitable means of identifying purchase transactions linked to the CISP may be used. In accordance with the CISP, such purchases may trigger a “round-up” function wherein an additional amount is automatically transferred to the CISP server and accumulated in the subscriber's account.

Second, the CISP also offers the possibility to invest in the CISP Investments any additional contributions an employer, a service provider (the “Service Provider”) or a supplier of goods and services may choose to make to top up the contributions generated by the Rounding-Up Savings Method and/or any card bonuses (the “CISP Top-Up”).

Third, the CISP offers the option of a contribution continuity guarantee (the “CISP Continuity Guarantee”) which allows subscribers to have their regular contributions funded for a pre-determined period in the event that they qualify as being temporarily unable to fund such contributions themselves.

Fourth, the CISP further offers to subscribers the possibility to receive and invest in the CISP Investments any continuity of contribution bonus paid out at pre-determined points in time based on the subscriber's contribution history in the CISP (the “CISP Continuity Bonus”).

Fifth, the CISP may be enhanced to offer a method by which subscribers will transfer/invest their savings (including those savings accumulated through card bonuses, the Rounding-Up Savings Method, the CISP Top-Up, the CISP Continuity Guarantee and the CISP Continuity Bonus) into different accounts selected in accordance with pre-established tax-efficient criteria (the “Intelligent Investment Method”).

Each of the above features is described in greater detail below.

The Rounding-Up Savings Method

The Rounding-Up Savings Method implements automated savings deposits which can be directly invested in a subscriber's pension plan. The operation of this Rounding-Up Savings Method is facilitated by the use of CISP credit or debit cards (the “CISP Cards”) which provide to the Service Provider the personalized savings and investment profile of any subscriber who chooses to adhere to the CISP. By presenting their CISP Card at the time of a purchase, a subscriber adds an incremental pre-determined quanta of money automatically to a credit or debit card purchase transaction and deposits those funds in accordance with his or her personalized savings and investment profile previously established with the Service Provider. The pre-determined quanta of money will represent the amount necessary to round-up the purchase to the nearest $5 or $10 for example, as may be established by the subscriber. The previously negotiated agreements between the Service Provider and the card issuer would enable the Service Provider to re-direct these funds from the credit or debit card issuer to the subscriber's preferred investment account(s), on behalf of the subscriber.

The CISP Top-Up

The CISP Top-Up allows an employer, the Service Provider and/or suppliers, to top-up existing contributions in a subscriber's CISP account, as some portion of either the regular contributions made by the subscriber, the additional contributions made under the round-up and card bonuses, or an aggregate of all or some of these contribution components. These top-up contributions will be calculated periodically and invested in the subscriber's CISP account, as either “available” funds able to be withdrawn at any time, or “vested” funds able to be withdrawn only at some future time, as determined by the CISP provisions.

The CISP Continuity Guarantee

The CISP Continuity Guarantee offers subscribers who qualify and are approved for this feature, the possibility to ensure that their regular contributions be continued, for a pre-determined period of time, in the event that they are not able to continue these themselves for reasons of hardship. The continuing contributions will be made under either a loan or an insurance agreement, by either the Service Provider or a partner organization within the CISP. Any costs for provision of this continuity guarantee will be shared between the subscriber, the Service Provider and the other partner organizations, on a pre determined formula.

The CISP Continuity Bonus

The CISP Continuity Bonus is another feature which allows for an amount to be calculated periodically and invested in the subscriber's account, based on historical contribution performance. Specifically, various thresholds of continuous periods of contributions, as prescribed in the CISP, will be set, and attainment of these thresholds by the subscriber will attract continuity bonuses, at a rate prescribed by the CISP. Contributions made under the CISP Continuity Guarantee feature detailed above will be included in determining the continuity bonus.

The Intelligent Investment Method

The Intelligent Investment Method is a feature which functions as a decision making model, to be applied, if authorized by the subscriber, to all funds being contributed to the subscriber's accounts within the CISP. The decision model will utilize the subscriber's personal information related to current and future investment goals, risk profile and holdings, in conjunction with up-to-date tax and other fiscal program details, to seek to automatically maximize the after-tax returns and other goal criteria established by the subscriber.

Mechanics

The operation of the CISP includes the mechanics of accumulating information and amounts from subscribers and routing these together with other attributes such as bonus amounts, vesting amounts and participant discounts from plan profit sharing. The CISP is predicated on essentially a ‘start small’ rationale, and as such is a technology geared to handling very small amounts in very high volumes.

It is anticipated that subscribers will establish ‘standing instructions’ within the CISP authorizing the Service Provider to effect the transactions the subscribers want.

The CISP server 2 may be implemented using computer, funds transfer, information capture and reporting capabilities and technologies of a type that are generally known in the art, and therefore will not be described in greater detail herein.

For example, in the case of the round up credit card, one basic equipment-process technology scenario my broadly operate as follows:

1. As a card-holder purchases goods or services, charged amounts plus the rounded up amounts are accumulated at the card-holder level by the card network provider's (e.g. Visa) card issuer. Conceptualizations: Computerized applications paralleling credit card statement production.

2. The card issuer supplies data on predetermined cycles (cardholder statement date, due date, etc.) to an interchange or to the Service Provider. These streams would include transaction data, account-holder name, amount, identifiers and tracers. Conceptualizations: Computer-to-computer/EFT applications similar to those used to effect payroll or consigned cheques functionalities.

3. Interchange routes monies to subscribers' accounts via the Service Provider protocols, and generates a debit amount (in this example, to the card issuer) for settlement. Conceptualizations: Back-end of 2 above with ACH/EFT user specific designations on pre-authorized debit. A different version could involve the card issuer providing data and funds in step 2, so that the reconciliation process is mandated to the Interchange.

4. The Service Provider, now in receipt of information and monies, effects investment and reporting functions per plan subscriber profile.

Differentiating the CISP as a comprehensive program

While most consumers' savings are done in an unplanned, ad hoc fashion, some disciplined savings approaches purporting to help are currently offered in the market-place. For example, some bank programs permit customers access to a range of tools to assist them in budgeting, reducing expenses or putting ‘cash-back’ amounts into their (credit card) accounts.

Also, some financial institutions will accept ‘standing instructions’ for clients which mechanize repetitive transactions. For example, a client may wish to send his/her daughter an amount each month to her account while she is attending boarding school.

It follows that ‘standing instructions’ can be used to repetitively transfer amounts to accumulate in a savings vehicle, such as Canada Savings Bonds, or RRSP's.

However, it is believed that none of these offerings is providing a comprehensive savings program linked to group savings; and/or comprising all or some of the CISP's five main features forming part of the present application.

Differentiating the 5 Main Features of the CISP

Card Round-Up on Purchases (the Rounding-Up Savings Method)

Increasing numbers of credit card issuers are furnishing a “cash back” credit card or are offering to accumulate points or other incentives attached to a debit card or credit card.

The majority of these offerings known to us all share characteristics which clearly characterize them as transaction-related products geared to accumulating points which can be used to purchase goods and services, rather than for savings or wealth accumulation.

Some credit cards offer the option to receive cash, as opposed to points, with the cash either applied to reducing amounts owed on purchases with the card, or paid out in the form of a cheque, for use by the cardholder as they wish; neither of these options can be reasonably considered to be encouraging savings or wealth accumulation.

Some credit cards offer the option to transfer cash rewards (card bonuses) on the card to an investment account held by the individual cardholder.

Some debit card programs allow the rounding up feature to be applied to the debit card purchases only, with the rounded up amounts then transferred automatically into a savings account held by the individual cardholder.

None of the programs mentioned above allow the round up feature on a credit card, nor do they allow either the round up or other card bonuses (cash back) to be deposited automatically to an investment account held by the cardholder in a “group” or “individual” savings plan.

Top-Up Bonuses (the CISP Top-Up)

Some of the “group” savings programs in existence today allow for employers to “top up” their employees' contributions, based on predetermined criteria, and tied to the employees' regular contributions.

None of the automated savings and investment programs in existence today allow for top-up contributions from employers based on their card purchase round up or other bonus contributions, as these additional contribution streams do not currently exist at all for group plans.

The CISP Continuity Guarantee

Some group savings programs currently allow a contribution “holiday” concept, where employees can suspend their contributions for a limited period of time without incurring any penalties.

Some individually held investment programs that are offered within a universal life policy allow for the funding of some or all of the premiums, required to keep the policy current, to be made by way of a loan facility.

To our knowledge, there is no group savings program that allows for a continuation of contributions to the savings and investment program, nor is there any such continuity of contribution guarantee available on individually held automatic investment and savings programs that are not part of a universal life insurance policy design.

The CISP Continuity Bonus

Some individually held investment and savings programs offer the participant an up-front bonus as an inducement to set up the plan.

Some individually held investment and savings programs offer the participant an ongoing bonus based on asset levels attained in the program.

To our knowledge, no automatic savings and investment program, of either the group or individually held nature, offer the participant a bonus based on the period of time they have been able to continue their contributions uninterrupted, nor is there any such program that provides for a “vesting” of such bonuses (allowing the withdrawal of such bonuses only at a pre-determined future time).

The Intelligent Investment Method

Some investment and savings programs, of both the group and individually held variety, offer tax maximization guidance through both literature and face-to-face counseling.

No investment and savings program, to our knowledge, offers an automated decision-making tool that can be applied to every contribution made, for the purpose of determining, and subsequently effecting, the most beneficial allocation of funds contributed, in terms of minimizing the overall tax cost to the participant. This determination is made with a combination of current tax constraints, as well as the individual profile and goals of the participant.

We Claim:

1. An automated savings and investment method and system comprising:
a Service Provider negotiating agreements with each one of a plurality of parties, each agreement defining terms under which deposit amounts can be transferred from the respective party to the Service Provider on behalf of one ore more subscribers;
the Service Provider defining, and negotiating if required, one or more enhanced services including respective terms under which deposit amounts transferred in accordance with the agreements can be supplemented with additional deposit amounts;
thereafter, the Service Provider:
instantiating a respective account associated with a subscriber;
identifying, from among the plurality of parties, a set of parties with which the subscriber has a financial relationship, and enabling the subscriber to subscribe to any one or more of the agreements;
identifying, from among the one or more enhanced services a set of permissible enhanced services to which the subscriber is permitted to subscribe, and enabling the subscriber to select at least one of the permissible enhanced services; and
establishing a respective profile for that subscriber, the profile including an identification of each one of the selected agreements and permissible enhanced services and investment preferences of the subscriber;
thereafter, for each one of a plurality of subscribers:
a server maintained by the Service Provider receiving deposit amounts under the terms of each one of the agreements and permissible enhanced services identified in the subscriber's profile;
the server accumulating the received deposit amounts in the account associated with the subscriber; and
the server automatically investing some or all of the accumulated deposit amounts in accordance with the investment preferences identified in the subscriber's profile.

2. The automated savings and investment method and system as claimed in claim 1, wherein the plurality of parties includes a credit card issuer, and wherein the deposit amounts comprise pre-authorized round-up amounts and credit card bonuses calculated in accordance with a service agreement between the subscriber and a card issuer.

3. The automated savings and investment method as claimed in claim 1, wherein the plurality of parties includes a debit card issuer, and wherein the deposit amounts comprise pre-authorized round-up amounts calculated in accordance with a service agreement between the subscriber and the debit card issuer.

4. The automated savings and investment method as claimed in claim 1, wherein the plurality of parties includes an employer of the subscriber, and wherein the deposit amounts comprise one or more of the subscriber's direct contributions, the subscriber's employer contributions and the subscriber's employer top-up contribution amounts.

5. The automated savings and investment method as claimed in claim 1, wherein the deposit amounts arising from the permissible enhanced services comprise any bonus amounts based on a period of time a subscriber has made contributions uninterrupted, together with a “vesting” of such bonus amounts allowing the withdrawal of such bonuses only at a pre-determined future time calculated in accordance with a services agreement between the subscriber and the Service Provider.

6. The automated savings and investment method as claimed in claim 1, wherein the deposit amounts arising from the permissible enhanced services comprise continued contributions calculated in accordance with a loan or an insurance agreement between the subscriber and either the Service Provider or a partner organization.

7. The automated savings and investment method as claimed in claim 1, wherein the deposit amounts arising from the permissible enhanced services are the result of an automated decision-making tool applied to every contribution made, and cross-referenced to the investment preferences profile of the subscriber, for the purpose of determining, and subsequently effecting, the most beneficial allocation of funds contributed, in terms of minimizing the overall tax cost to the subscriber, in accordance with a services agreement between the subscriber and the Service Provider.
